(19) United States
(12) Patent Application Publication
(10) Pub. No.: US 2007/0228111 A1
(43) Pub. Date: Oct. 4, 2007

(54) Microelectronic package and method of forming same

(76) Inventors: Ganesh V. Vasudevanpillai, Chandler, AZ (US); Mukul P. Renavikar, Chandler, AZ (US); Jessica A. Weninger, Phoenix, AZ (US)

Correspondence Address: INTEL CORPORATION;c/o INTELLEVATE, LLC, P.O. BOX 52050, MINNEAPOLIS, MN, 55402, US

(21) Appl. No.: 11/393,184

(22) Filed: Mar. 29, 2006

(51) Int. Cl. B23K 31/00; B23K 31/02

(52) U.S. Cl. 228/180.22

(57) ABSTRACT

A method of forming a microelectronic package, a microelectronic package formed according to the method, and a system including the microelectronic package. The method comprises: providing a die-substrate combination including: providing a die having die bumping sites thereon each including a layer comprising a stabilizing element; providing a substrate having substrate bumping sites thereon; before heating, placing a solder on at least one of the die bumping sites and the substrate bumping sites, the solder including a first solder element and a second solder element; and placing the die and the substrate in registration with one another to sandwich the solder therebetween. The method further comprises forming a plurality of joint structures including heating the die-substrate combination to reflow the solder. Each of the joint structures includes: IMC grains comprising the stabilizing element and the first solder element; and solidified solder comprising the first solder element and the second solder element. Preferably, the stabilizing element comprises Au, the first solder element comprises In, and the second solder element comprises Sn.

### FIELD

Embodiments of the present invention relate to methods of packaging microelectronic devices.

### BACKGROUND

Current methods of forming microelectronic packages comprise using lead-free solders including, for example, SnIn or SnInCu as lead-free, low-stress options to be used instead of SnAg. However, in packages using SnIn or SnInCu solder pastes, separation is typically observed on the die side of the package, and sometimes on the substrate side of the package as well.

Where the substrate surface finish includes NiPdAu, as is sometimes used in the art to prevent intermetallic compound (IMC) formation at the substrate side, substrate-side separation of the joints is no longer observed, but die-side separation remains a problem. Where the substrate surface finish comprises ENIG pads (that is, substrate bumping sites including a barrier layer comprising a layer of Ni capped by a layer of Au), separation on the die-side observed with the use of SnIn and SnInCu solder pastes is prevalent.

However, where the ENIG pads are supplemented with an additional EG finish (typically including an additional Au layer having a thickness of about 400 nm), separation of the die-side and on the substrate-side are eliminated. On the other hand, provision of the additional EG finish disadvantageously increases manufacturing costs and further increases output time, at least in part by requiring the provision of Au typically on both sides of the substrate.

The prior art fails to provide a method of fabricating a cost-effective microelectronic package that includes reliable lead-free solder joints between the package die and the package substrate.

### BRIEF DESCRIPTION OF THE DRAWINGS

Embodiments of the invention are illustrated by way of example and not by way of limitation in the figures of the accompanying drawings, in which the like references indicate similar elements and in which:

FIG. 1 is a schematic cross-sectional view of a microelectronic package according to an embodiment;

FIG. 2 is a schematic cross-sectional view of one of the joint structures of the package of FIG. 1;

FIGS. 3 and 4 are schematic cross-sectional views showing stages in the formation of the joint structure of FIG. 2 according to an embodiment;

FIG. 5 is a schematic cross-sectional view of a bonded die-substrate combination obtained from following the stages of FIGS. 3-8;

FIG. 6 is a schematic cross-sectional view showing a dispensing of underfill material in a space between the die and the substrate of the combination of FIG. 9 according to an embodiment; and

FIG. 7 shows a system including a package such as the package of FIG. 1 according to an embodiment.

For simplicity and clarity of illustration, elements in the drawings have not necessarily been drawn to scale. For example, the dimensions of some of the elements may be exaggerated relative to other elements for clarity. Where considered appropriate, reference numerals have been repeated among the drawings to indicate corresponding or analogous elements.

### DETAILED DESCRIPTION

In the following detailed description, a microelectronic package, a microelectronic substrate, a method of forming the package, and a system including the package are disclosed. Reference is made to the accompanying drawings within which are shown, by way of illustration, specific embodiments by which the present invention may be practiced. It is to be understood that other embodiments may exist and that other structural changes may be made without departing from the scope and spirit of the present invention.

The terms on, above, below, and adjacent as used herein refer to the position of one component relative to other components. As such, a first component disposed on, above, or below a second component may be directly in contact with the second component or it may include one or more intervening components. In addition, a first component disposed next to or adjacent a second component may be directly in contact with the second component or it may include one or more intervening components. In addition, a “layer” as used herein may refer to a layer made of a single material, a layer made of a mixture of different components, a layer made of various sub-layers, each sublayer also having the same definition of layer as set forth above. In addition, by a “die-side” and “substrate-side,” what is meant in the context of the present description is, respectively, “closer to the die than to the substrate” and “closer to the substrate than to the die.”

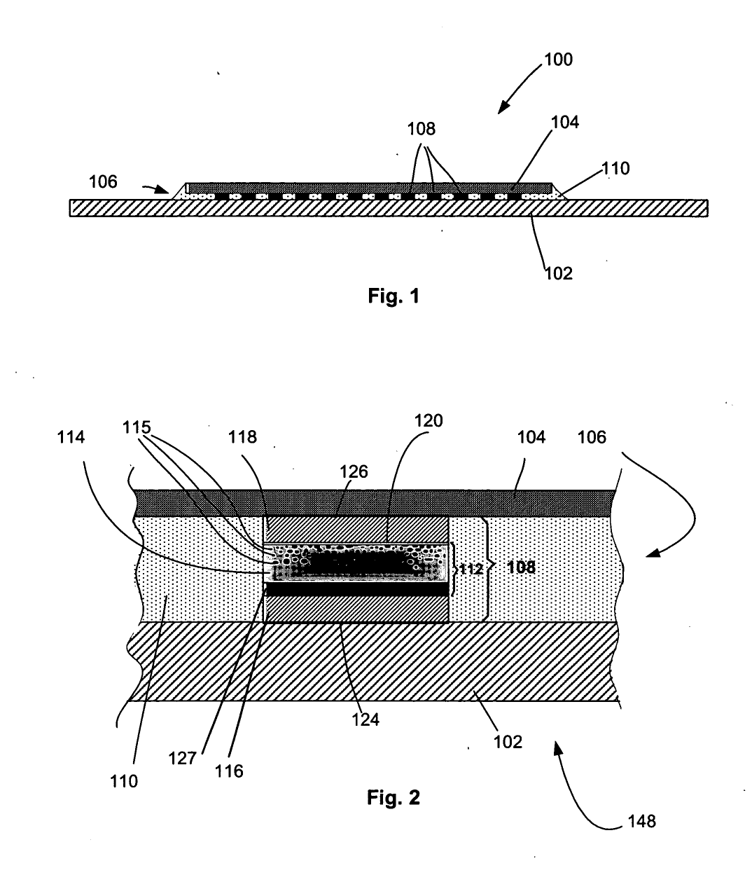

In one embodiment, a microelectronic package is disclosed. In one embodiment, a microelectronic substrate is disclosed. In another embodiment, a method to form a microelectronic package is disclosed. In yet another embodiment, a system including a microelectronic package is enclosed. Aspects of these and other embodiments will be discussed herein with respect to FIGS. 1-11, below. The figures, however, should not be taken to be limiting, as they are intended for the purpose of explanation and understanding.

In FIG. 1, an embodiment of a microelectronic package is disclosed. As seen in FIG. 1, a microelectronic package 100 includes a substrate 102, and a die 104 bonded to the substrate by a bond 106. By “bond,” what is referred to in the context of the present invention is at least an electrical joint between the die and the substrate. The bond may further include a mechanical joint between the die and the substrate. As seen in FIG. 1, a plurality of joint structures 108 are shown between the die and the substrate, the joint structures 108 forming part of bond 106 to at least electrically join the die to the substrate. In the shown embodiment, bond 106 further includes a cured underfill material 110, which may include any one of the underfill materials well known in the art, such as, for example, epoxy or the like.

Referring now to FIG. 2, an embodiment is shown for at least one of the joint structures. In the shown embodiment, the at least one of the joint structures 108 includes a layer 112 comprising solidified solder 114, a die-side (intermetallic compound) IMC layer 120, a substrate-side IMC layer 127, and IMC grains 115.

IMC grains 115 include a combination of a stabilizing element with a first solder element. The first and first solder elements are chosen such that a free energy of formation of their IMC has an absolute value that is higher than an absolute value of a free energy of formation of an IMC of the stabilizing element with any other element present in the layer 112. What the above means is that the IMC of the stabilizing element and the first solder element is, according to embodiments, is thermodynamically more stable that an IMC of the stabilizing element with any other element in layer 112 of the joint. Preferably, the stabilizing element comprises either Au or Pd, and the first solder element comprises Indium. More preferably, the stabilizing element comprises Au. As seen in FIG. 2, according to an embodiment, the IMC grains 115 are present a higher concentration toward the die side of layer 112 than toward the middle of layer 112.

The solidified solder 114 may comprise a mixture including the first solder element, and at least a second solder element. According to an embodiment, the first solder element may comprise In, and the second solder element may comprise Sn. In the latter case, the solder may, according to some embodiments, include SnIn or SnInCu. For example, where the solder paste used prior to reflow contains about 85% by weight Sn, about 14% by weight In and about 1% by weight Cu (hereinafter 85Sn-14In-1Cu), the solidified solder 114 may contain Sn, In and Cu in various amounts.

The die-side IMC layer 120 may comprise an IMC including the second solder element and an electrically conductive element. Thus, for example where the solder used comprises a Sn-based solder, such as, for example, SnIn or SnInCu, and further where an electrically conductive layer on the die bumping site comprises a Cu layer, then, the die-side IMC layer may comprise, according to an embodiment, CuSn, that is, a combination of Sn as the second solder element, with Cu as the electrically conductive element. By “bumping site,” what is meant in the context of the instant application is a site including one or more metallization layers on a bonding pad of a microelectronic component (such as, for example, a die or a substrate), the bumping site adapted to allow an electrical and mechanical joining of the microelectronic component with another microelectronic component, such as through a solder connection. An example of a bumping site as used herein would comprise an ENIG pad.

Although not shown in FIG. 2, embodiments comprise within their scope a joint structure 108 which includes one or more supplemental die-side IMC layers and/or supplemental die-side IMC grains including one or more of the solder elements combined with elements present in the original die bumping site, such as, for example, a barrier layer element including, for instance Ni.

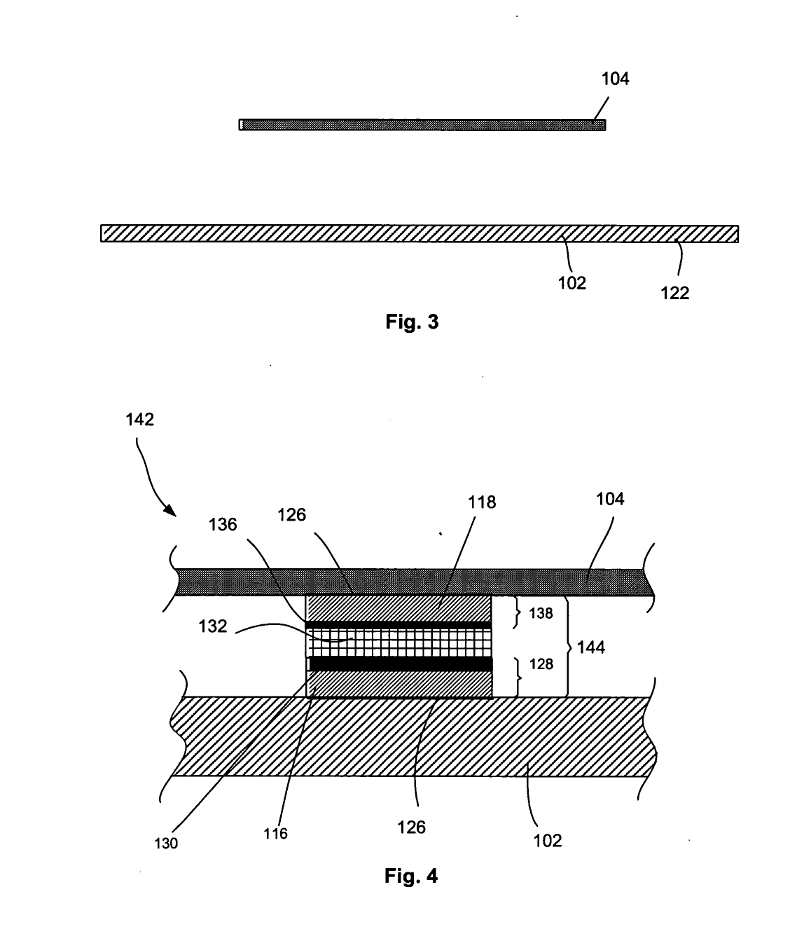

With respect to the substrate-side IMC layer 127, where a barrier layer, such as, for example, a layer comprising Ni, is provided on the substrate bumping site prior to reflow of the solder (as will be shown and explained with respect to FIG. 4 infra), an element of the barrier layer (or barrier layer element) may combine, during a cooling of the solder after reflow, with one or more elements of the solder paste (or solder elements) or of the electrically conductive layer (or electrically conductive element) on the substrate to form the substrate-side IMC layer. According to an embodiment, the IMC layer 127 may include a layer of juxtaposed IMC grains. By “barrier layer,” what is meant in the context of the present invention is a layer adapted to prevent a migration of electrically conductive material from the first electrically conductive material, as is recognized by persons skilled in the art. For example, the substrate-side IMC layer 127 may comprise a combination of the second solder element with a barrier layer element. Thus, where the barrier layer element comprises Ni, where the second solder element is Sn (such as, for example, in a solder comprising SnIn or SnInCu), and where the electrically conductive element comprises Cu, the substrate-side IMC layer may comprise (NiSn)Cu. The Cu in the (NiSn)Cu may be provided from Cu as the electrically conductive element in the substrate bumping sites, or, possibly, from Cu present in the solder, such as where the solder comprises SnInCu.

Referring still to FIG. 2, accordingly to a preferred embodiment of the joint structures, the layer 112 in the joint structures 108 is a middle layer 112 disposed between a first electrically conductive layer 116 adjacent the substrate, and a second electrically conductive layer 118 adjacent the die. According to a preferred embodiment, the first and second electrically conductive layers comprise respective Cu layers directly in contact with, respectively, the substrate and the die bonding pads, such as bonding pads 126 and 124, respectively. By “bonding pad,” what is meant in the context of the present description is the portion of the conductive pattern on printed circuits on either the die or the substrate designed to allow an electrical bonding of the die or substrate to external circuitry. The first and second electrically conductive layer may also comprise Al or Ag. It is noted that, although the shown embodiment shows only the layers described above, embodiments comprise within their scope the provision of additional layers in the joint structure as long as the && is present. As also seen in FIG. 2, a cured underfill material 110 may be provided between the joint structures in the space between the die and the substrate. The cured underfill material may comprise any well known underfill material, such as, for example, epoxy. According to one embodiment, the underfill material comprises an underfill material which may be dispensed according to a capillary underfill regime, and thereafter cured.

Referring next to FIGS. 3-4, a method embodiment to form a microelectronic package by such as the package of FIGS. 1-2 by bonding a die to a substrate will be described.

Referring now to FIG. 3 by way of example, embodiments contemplate the provision of a substrate 102 and of a die 104 to be bonded to the substrate. The substrate may include a wafer 122 including circuitry (not shown) within the wafer, the circuitry including a plurality of bonding pads 124 (FIG. 2), as would be recognized by one skilled in the art. The die may further include any microelectronic die including circuitry having bonding pads 126 (FIG. 2) as would be recognized by one skilled in the art.

Referring now to FIG. 4 by way of example, some embodiments contemplate providing bumping sites on the die bonding pads and on the substrate bonding pads. Thus, as seen in FIG. 4, embodiments contemplate providing bumping sites such as bumping site 128 on the substrate bonding pads 124 as shown. The substrate bumping site 128 may include the first electrically conductive layer 116, and, optionally, a barrier layer 130 thereon as previously described. According to one embodiment, the barrier layer 130 may comprise Ni. Optionally, the substrate bumping site 126 may comprise an ENIG pad (not shown), or a NiPdAu surface finish (not shown), both configurations being well known in the art.

Referring still to FIG. 4 by way of example, an embodiment may further include the provision of bumping sites on the die bonding pads 126. Thus, in a preferred embodiment, die bumping sites 138 may include the second electrically conductive layer 118, and a layer 136 including the stabilizing element, such as, preferably, a layer comprising Au or Pd, and, more preferably, a layer comprising Au. Optionally, as mentioned above, the die bumping site may also include a barrier layer, or any other metal layer according to application needs (not shown). The layers in the bumping sites 128 and 138, such as, for example, Cu layers, Ni layers and Au layers may be provided according to any one of well known methods, such as, for example, through electroless or electrolytic plating, as would be recognized by one skilled in the art. A thickness of the layer 136 comprising the stabilizing element is among other things a function of the amount of the first solder element present within the solder mixture. According to embodiments, the amount of the stabilizing element provided in layer 136 may more precisely be a function of the amount of the first solder element to be scavenged from the solder mixture to prevent the formation, at the die-solder interface, of a phase of the solder rich in the first solder element. Thus, where the solder comprises SnIn or SnInCu (in which case the first solder element would comprise In), then, the thickness of the layer 136 would be among other things a function of the amount of In adapted to combine with the stabilizing element in layer 136 to prevent the formation of an In-rich phase at the die-solder interface by forming the die-side IMC layer 120 and IMC grains 115, as would be recognized by one skilled in the art. By way of example, in a conventional bonding application involving a solder containing about 85% by weight Sn, about 14% by weight In and about 1% by weight Cu, a thickness of a layer 136 comprising Au may be about 300 nm in order to ensure an effective scavenging of the In away from the solder during cooling and solidification to prevent the formation of an In-rich phase at the die-solder interface. A thickness of a layer 136 comprising Pd in the same situation as noted above may be about 300 nm. In general, where the stabilizing element is Au, and the first solder element is In, the weight of Au to be provided in the die bumping site would, according to an embodiment, be about ¼ to about ⅓ of the weight of the In present in the solder. Where the stabilizing element is Pd, and the first solder element is In, the weight of the Pd to be provided in the die bumping site would, according to an embodiment, be about ⅓ to about ½ of the weight of the In present in the solder.

Referring still to FIG. 4 by way of example, an embodiment may additionally include providing solder 132 between the die 104 and the substrate 102 as shown, the solder comprising the first solder element and the second solder element. According to some embodiments, the first solder element comprises In, and the second solder element comprises Sn. For example, the solder 132 may be provided by providing a solder paste onto either one of the substrate bumping site 128 and the die bumping site 138. According to a preferred embodiment, the solder paste includes either a SnIn or a SnInCu, including about 85% Sn, about 14% In and about 1% Cu by weight. Provision of lead-free solders is advantageous to the extent that it allows the use of environmentally non-hazardous solder materials. Lead-free solders containing solder elements such as In, for example, further advantageously have a lower melting temperature and a higher softness than typical non-In-containing solders, in this way reducing stresses typically visited upon the die during soldering.

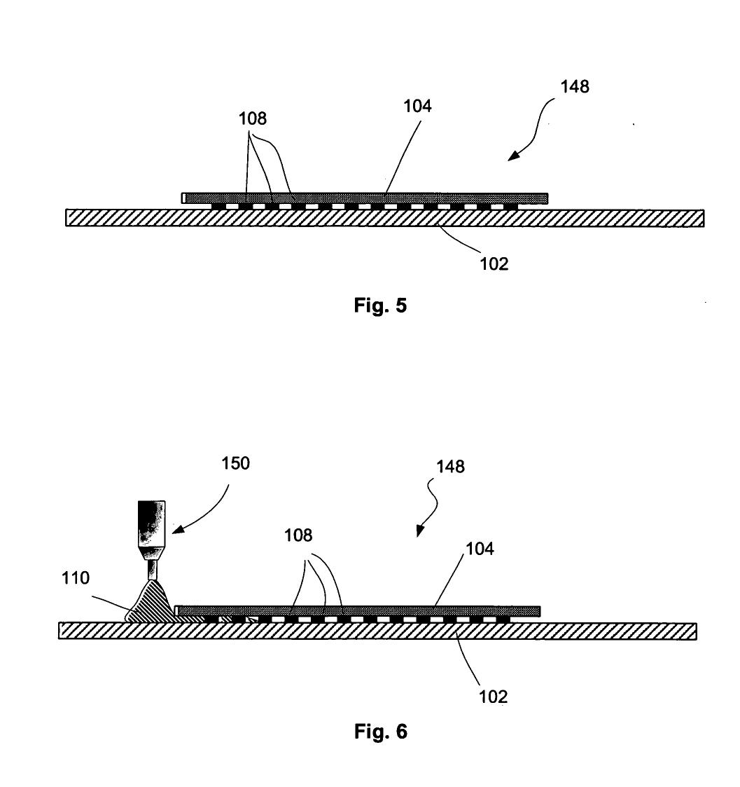

Referring next to FIG. 5 by way of example, embodiments comprise placing the die 104 onto the substrate 102 such that the substrate bumping sites 128 and the die bumping sites 138 are placed in registration with one another and such that the solder is placed between the respective bumping sites, to form a die-substrate combination 142 including pairs such as pair 144 of registered die and substrate bumping sites sandwiching solder therebetween. As previously suggested above, reflowing of the solder may take place after placing the die onto the substrate.

Referring still to FIG. 5 by way of example, embodiments include forming joint structures from each pair 144 of die and substrate bumping sites including heating the die-substrate combination 142 to effect reflow of the solder in a conventional manner. For example, when the solder 132 comprises either SnInCu or SnIn, a heating temperature range of the joint would be about 200 to about 240 degrees Centigrade for up to about 2 minutes. A heating temperature range for heating the die-substrate combination may be obtained from a phase diagram of the solder, as would be recognized by one skilled in the art. In one embodiment, heat is applied to the combination 142 to a temperature that approaches or achieves the solidus temperature of the specific solder 132. Heating as described above according to embodiments results in a melting of the solder, and further results in dissolution of the layer 136, such as a Au layer or a Pd layer, into the molten solder. A dissolution of layer 136 including the stabilizing element in turn brings about an exposure of the electrically conductive layer containing the electrically conductive element, such as, for example, Cu, to the melted solder. During cooling the electrically conductive element then, according to an embodiment, forms an IMC with at least one element in the solder, such as, for example, Sn, in order to form CuSn as the die-side IMC layer 120. During cooling, the stabilizing element dissolved within the solder, such as, for example, Au or Pd, then joins with the first solder element present within the solder to form the IMC grains 115, such as AuIn2 IMC. In addition, during cooling, the barrier layer element, such as, for example, Ni, may joint with the second solder element, such as Sn, and with the electrically conductive element, such as Cu, to form NiSnCu as described above.

Referring back to FIG. 2, after a reflow of the solder has taken place in a well known manner, the die-substrate combination 142 including the joint 144 is allowed to cool. A cooling of joint 144 thus results, as explained above, in the formation of the joint configuration 108 as shown, including a formation of the solder 114, and of the IMC's including the substrate-side IMC layer 127, the die-side IMC layer 120, and IMC grains 115 as described above. Where there is no barrier layer 130 provided as part of the substrate bumping site, then, the substrate-side IMC layer 127 would not present in FIG. 2 (not shown), but the joint would still include the die-side IMC layer 120 and the IMC grain 115. Where the solder 132 as shown in FIG. 4 contains In as the first solder element, such as, for example, when the solder 132 in FIG. 4 comprises SnInCu or SnIn, then, it would be preferable according to embodiments for the layer 136 in the die bumping site 138 to include Au or Pd, and, preferably, Au as the stabilizing element. In such a case, during cooling, the stabilizing element such as the Au or Pd would scavenge the In out of the solder 132 to form the die-side IMC layer 120 and the IMC grains 115.

It has been found that failures in prior art solder joints including In-containing solders result at least in part by way of a formation of an In rich phase of the solder during cooling at the interfaces of the solder with the die Cu bumps and at times at the interfaces of the solder at the substrate side. The In-rich phase has been found to form as a result of a preferential consumption, in the form of IMC formation, of the Sn in the solder by Ni in the substrate barrier layer, or by Cu present in at the interfaces mentioned above and/or by Cu in the bulk solder. Since the solidification temperature of the In-rich phase occurs at much lower temperatures than a solidification of the solder mixture, solidification of the In-rich phase takes longer than the solidification of the rest of the solder, resulting in a separation of the die from the substrate at the IMC solder interfaces. According to embodiments, using a cap made of a stabilizing element as described above, such as, preferably, Au and Pd, and, more preferably, Au, will preferentially form In-rich IMC's in the solder joint, thereby locking up the In from the solder, in this way preventing IMC-solder separation as observed in the prior art. Thus, during cooling, more and more of the stabilizing element now present within the molten solder forms the die-side IMC layer 120 and the IMC grains 115, until the temperature of the joint drops below a liquidus temperature of the same, and a joint structure 108 is formed as shown and described above with respect to FIG. 2.

A formation of the joint structures 108 as described above may result in a bonded die-substrate combination such as combination 148 shown in FIG. 2. Thus, as seen in FIG. 2 by way of example, embodiments contemplate the provision of a bonded die-substrate combination (in the sense of at least an electrical bond between die and substrate) including the substrate 102, the die 104, and joint structures 108.

Referring next to FIG. 5, an embodiment contemplates applying an underfill material to a space between the die and the substrate after forming the plurality of joint structures, and curing the underfill material. Preferably, the underfill material 111 may be dispensed in uncured or partially cured form using capillary underfill techniques as described above, such as, for example, by way of an underfill dispensing system 150 as shown in FIG. 5, as would be within the knowledge of a person skilled in the art. System 150 may be controlled to dispense underfill material after a predetermined time corresponding to a time needed for joint formation, that is, corresponding to a time needed for the temperature of the die-substrate combination to drop below a liquidus temperature of the joint. Underfill material may, by way of example, include an epoxy-containing underfill material, or any other of the well known underfill materials as would be within the knowledge of one skilled in the art. The underfill material 111 may then be fully cured into cured underfill material 110 as shown in FIG. 2, such as by being heated in a cure oven in a well known manner, in order to yield a package such as package 100 of FIG. 1. Preferably, the joint structures are kept at a temperature corresponding to a curing temperature of the underfill material dispensed until after curing of the underfill material in order to prevent damage to the die and/or substrate as a result of a cooling of the joint structures and a mismatch between respective CTE's of the die and of the substrate. To achieve the above, according to one embodiment, the joint formation site for the solder and the cure equipment for the underfill material may be placed close to one another.

Advantageously, embodiments provide a reliable, cost-effective method of bonding a die to a substrate to form a package thereof using lead-free solders containing a solder element such as In. Solder elements such as In allow the solders used according to embodiments to have a lower melting temperature and an increased softness with respect to solders not containing such solder elements. According to an embodiment, where the solder contains In, as in the case of, for example, SnIn or SnInCu, by plating alternate metals layers, such as, for example, Au or Pd, onto the die bumping sites, the formation of an In rich phase at the interface of the solder with the die bumping site may be substantially prevented, thus advantageously eliminating IMC/solder separation. Additionally, because embodiments provide for a provision of a stabilizing element cap on the die bumping sites rather than on the substrate, they advantageously substantially eliminate solder separation during soldering while making the process flow faster and more cost-effective by effecting a modification of the process flow at the wafer level. Providing the stabilizing element cap at the wafer level advantageously speeds up the manufacturing process while requiring a lower amount of the stabilizing element per package. A substrate surface finish would typically require a larger surface area per package to be provided with Au. In addition, any additional process flow stage at the substrate level would typically take longer than at the wafer level, among other things because of the differences in manufacturing scales between the two above-mentioned levels.

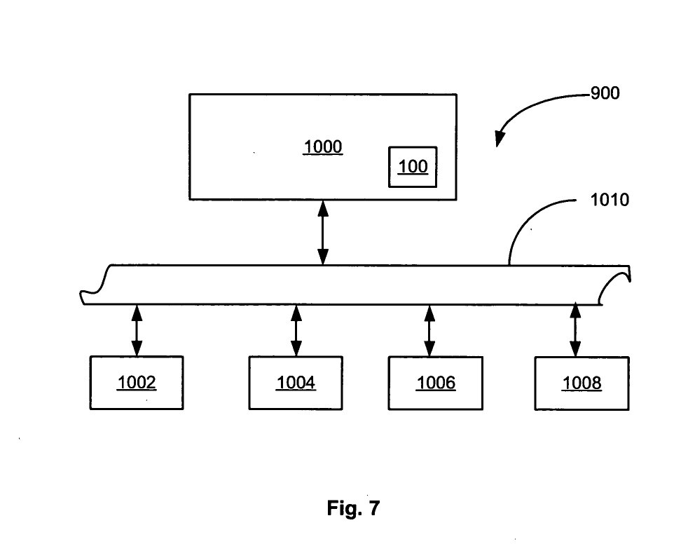

Referring to FIG. 6, there is illustrated one of many possible systems 900 in which embodiments of the present invention may be used. In one embodiment, the electronic assembly 1000 may include a microelectronic package, such as package 100 of FIG. 1. Assembly 1000 may further include a microprocessor. In an alternate embodiment, the electronic assembly 1000 may include an application specific IC (ASIC). Integrated circuits found in chipsets (e.g., graphics, sound, and control chipsets) may also be packaged in accordance with embodiments of this invention.

For the embodiment depicted by FIG. 6, the system 90 may also include a main memory 1002, a graphics processor 1004, a mass storage device 1006, and/or an input/output module 1008 coupled to each other by way of a bus 1010, as shown. Examples of the memory 1002 include but are not limited to static random access memory (SRAM) and dynamic random access memory (DRAM). Examples of the mass storage device 1006 include but are not limited to a hard disk drive, a compact disk drive (CD), a digital versatile disk drive (DVD), and so forth. Examples of the input/output module 1008 include but are not limited to a keyboard, cursor control arrangements, a display, a network interface, and so forth. Examples of the bus 1010 include but are not limited to a peripheral control interface (PCI) bus, and Industry Standard Architecture (ISA) bus, and so forth. In various embodiments, the system 90 may be a wireless mobile phone, a personal digital assistant, a pocket PC, a tablet PC, a notebook PC, a desktop computer, a set-top box, a media-center PC, a DVD player, and a server.

Having thus described in detail embodiments of the present invention, it is understood that the invention defined by the appended claims is not to be limited by particular details set forth in the above description, as many apparent variations thereof are possible without departing from the spirit or scope thereof.

What is claimed is:

1. A method of forming a microelectronic package comprising:
providing a die-substrate combination including:
providing a die having die bumping sites thereon, each of the die bumping sites including a layer comprising a stabilizing element;
providing a substrate having substrate bumping sites thereon;
before heating, placing a solder on at least one of the die bumping sites and the substrate bumping sites, the solder including a first solder element and a second solder element;
placing the die and the substrate in registration with one another to sandwich the solder therebetween;
forming a plurality of joint structures including: heating the die-substrate combination to reflow the solder; and cooling the solder to solidify the solder; wherein each of the joint structures includes: IMC grains comprising the stabilizing element and the first solder element; and solidified solder comprising the first solder element and the second solder element.

2. The method of claim 1, wherein:
the stabilizing element comprises one of Au and Pd; and
the first solder element comprises In.

3. The method of claim 2, wherein the second solder element comprises Sn.

4. The method of claim 1, wherein each of the substrate bumping sites comprises a barrier layer comprising a barrier layer element.

5. The method of claim 4, wherein the barrier layer element comprises Ni.

6. The method of claim 4, wherein each of the joint structures further comprises a substrate-side IMC layer comprising the barrier layer element and the second solder element.

7. The method of claim 6, wherein the barrier element comprises Ni, the second solder element comprises Sn, and the substrate-side IMC layer comprises NiSnCu.

8. The method of claim 4, wherein each of the substrate bumping sites comprises one of an ENIG pad and a NiPdAu surface finish.

9. The method of claim 1, wherein:
each of the die bumping sites comprises an electrically conductive layer including an electrically conductive element; and
each of the joint structures further comprises a die-side IMC comprising the electrically conductive element and the second solder element.

10. The method of claim 1, wherein:
each of the die bumping sites comprises:
an electrically conductive layer including an electrically conductive element;
a barrier layer comprising a barrier layer element and disposed on the electrically conductive layer; and
each of the joint structures further comprises a die-side IMC comprising the barrier layer element.

11. The method of claim 9, wherein each of the die bumping sites further includes an electrically conductive layer comprising Cu, the second solder element comprises Sn, and the die-side IMC comprises CuSn.

12. The method of claim 1, wherein the first solder element comprises In, the second solder element comprises Sn, and the solder comprises one of SnIn and SnInCu.

13. The method of claim 12, wherein the SnInCu solder comprises about 85% by weight Sn, about 14% by weight In, and about 1% by weight Cu.

14. The method of claim 1, further comprising providing an underfill material between the die and the substrate and curing the underfill material.

15. The method of claim 14, wherein the underfill material comprises epoxy.

16. The method of claim 13, wherein providing an underfill material comprises providing the underfill material between the die and the substrate through capillary action.

17. The method of claim 2, wherein the stabilizing element is Au, and a weight of the stabilizing element present in the die bumping site is between about ¼ and about ⅓ of the weight of the In present in the solder prior to heating.

18. The method of claim 2, wherein the stabilizing element is Pd, and a weight of the stabilizing element present in the die bumping site is between about ⅓ and about ½ of the weight of the In present in the solder prior to heating.

19. The method of claim 1, wherein the substrate bumping site comprises a layer including the stabilizing element.

20. The method of claim 19, wherein the stabilizing element comprises Au, and a total weight of the stabilizing element present in the die bumping site and in the substrate bumping site is between about ¼ and about ⅓ of the weight of the first solder element present in the solder prior to heating.

21. The method of claim 19, wherein the stabilizing element comprises Pd, and a total weight of the stabilizing element present in the die bumping site and in the substrate bumping site is between about ⅓ and about ½ of the weight of the first solder element present in the solder prior to heating.

22. A microelectronic package comprising:
a substrate;
a die bonded to the substrate;
a plurality of joint structures electrically bonding the die to the substrate, each of the joint structures including IMC grains comprising Pd and the first solder element; and solidified solder comprising the first solder element and the second solder element.

23. The microelectronic package of claim 22, wherein the first solder element comprises In, and the second solder element comprises Sn.

24. The microelectronic package of claim 22, wherein each of the joint structures further includes a substrate-side IMC layer comprising a barrier layer element.

25. The microelectronic package of claim 22, wherein each of the joint structures further comprises one of a supplemental die-side IMC layer and supplemental die-side IMC grains comprising a barrier layer element and an element of the solder.

26. A microelectronic die comprising:
a die body;
a plurality of bumping sites on the active surface of the die body, each of the bumping sites including a Pd cap thereon.

27. The die of claim 26, wherein the bumping sites comprise a barrier layer.

28. A system comprising:
an electronic assembly including:
a microelectronic package comprising:
a substrate;
a die bonded to the substrate;
a plurality of joint structures electrically bonding the die to the substrate, each of the joint structures including IMC grains comprising Pd and the first solder element; and solidified solder comprising the first solder element and the second solder element; and
a main memory coupled to the electronic assembly.

29. The system of claim 28, wherein the first solder element comprises In, and the second solder element comprises Sn.

30. The system of claim 28, wherein each of the joint structures further includes a substrate-side IMC layer comprising a barrier layer element.
